(19) United States
(12) Patent Application Publication
(10) Pub. No.: US 2014/0198135 A1
(43) Pub. Date: Jul. 17, 2014

(54) ORGANIC LIGHT EMITTING DISPLAY DEVICE

(71) Applicants: Ki-Myeong Eom, Yongin-City (KR); Mi-Hae Kim, Yongin-City (KR)

(72) Inventors: Ki-Myeong Eom, Yongin-City (KR); Mi-Hae Kim, Yongin-City (KR)

(21) Appl. No.: 13/933,056

(22) Filed: Jul. 1, 2013

(30) Foreign Application Priority Data
Jan. 17, 2013 (KR) 10-2013-0005455

(51) Int. Cl. G09G 3/32

(52) U.S. Cl. CPC G09G 3/3208
USPC 345/690; 345/82

(57) ABSTRACT

Provided is an organic light emitting display device including: a scan driver configured to supply a scan signal to a scan line during a scan period of a horizontal period; a data driver configured to supply a plurality of data signals to a plurality of output lines during a data period of the horizontal period; a demultiplexer configured to transmit the data signals through the output lines to a plurality of data lines according to a plurality of control signals; and a demultiplexer controller configured to supply the control signals to the demultiplexer, with a supply order of the control signals being changed for each frame.

### CROSS-REFERENCE TO RELATED APPLICATION

This application claims priority to and the benefit of Korean Patent Application No. 10-2013-0005455, filed on Jan. 17, 2013, in the Korean Intellectual Property Office, the entire content of which is incorporated herein by reference.

### BACKGROUND

1. Field

Embodiments of the present invention relate to an organic light emitting display device.

2. Description of the Related Art

Recently, various flat panel display devices having reduced weight and volume as compared to the weight and volume of cathode ray tubes, have been developed. Flat panel display devices include, for example, liquid crystal displays, field emission displays, plasma display panels, organic light emitting display devices, and the like.

An organic light emitting display device among flat panel display devices, displays an image using organic light emitting diodes capable of generating light by recombination between electrons and holes. The organic light emitting display device as described above, has characteristics such as a rapid response speed and requiring a relatively low driving power. A general organic light emitting display device supplies current corresponding to a data signal using a transistor formed at each of pixels, so as to emit light from an organic light emitting diode.

The organic light emitting display device as described above may include: a data driving unit for supplying data signals to data lines, a scan driving unit for sequentially supplying scan signals to scan lines, and a display unit including a plurality of pixels coupled to the scan lines and the data lines.

In addition, a demultiplexer (DEMUX) may be coupled to each output line of the data driving unit in order to reduce manufacturing cost. The demultiplexer performs time-division to a plurality of data signals respectively supplied to each output line and supplies the data signals to a plurality of data lines. Here, in the case in which a demultiplexer is included in an organic light emitting display device, a horizontal period is divided into a data period (or demultiplexer control signal supplying period) and a scan period, and driven.

During the data period, control signals are sequentially supplied to the demultiplexer so that a plurality of the data signals are sequentially transmitted to a plurality of the data lines. The scan signals are supplied to the scan lines during the scan period, such that the data signals transmitted to the data lines are transmitted to the pixels positioned on the corresponding horizontal line.

Meanwhile, when a horizontal period is divided into a data period and a scan period as described above, a period in which the data signals are supplied to each pixel is reduced. In order to overcome the above described problem, a method of supplying the scan signal to overlap the last control signal supplied during the data period has been proposed. However, when the last control signal and the scan signal are overlapped with each other, the amount of voltage charged between pixels corresponding to the same data signal may be different, and therefore, a non-uniform image may be displayed. Furthermore, when the last control signal is overlapped with the scan signal a phenomenon of vertical line-shaped defects may be generated in the image.

### SUMMARY

Accordingly, aspects of the embodiments of the present invention include providing an organic light emitting display device capable of displaying a uniform image.

An organic light emitting display device according to an embodiment of the present invention includes: a scan driver configured to supply a scan signal to a scan line during a scan period of a horizontal period; a data driver configured to supply a plurality of data signals to a plurality of output lines during a data period of the horizontal period; a demultiplexer configured to transmit the data signals through the output lines to a plurality of data lines according to a plurality of control signals; and a demultiplexer controller configured to supply the control signals to the demultiplexer, with a supply order of the control signals being changed for each frame.

A final control signal of the control signals supplied during the data period may be at least partially overlapped with the scan signal.

The demultiplexer controller may be configured to supply the control signals in a first order during an i (i indicates an integer) frame period, and may be configured to supply the control signals in a second order, which is reversed from the first order, during an i+1 frame period.

The demultiplexer controller may be configured to change a supplying order of the control signals for each horizontal period.

The scan signal may be supplied in a first order and then a second order, which is reverses from the first order, based on the horizontal period.

An organic light emitting display device according to another embodiment of the present invention includes: a scan driver configured to supply a scan signal to a scan line during a scan period of a horizontal period; a data driver configured to supply a plurality of data signals to a plurality of output lines during a data period of the horizontal period; a demultiplexer unit configured to transmit the data signals through the output lines to a plurality of data lines according to a plurality of control signals; and a demultiplexer controller configured to supply the control signals to a plurality of demultiplexers while a supply order of the control signals is changed in each frame; wherein the demultiplexers comprise: a first demultiplexer configured to supply first data signals of the data signals to first data lines of the data lines coupled to a plurality of first pixels; a second demultiplexer configured to supply second data signals of the data signals to second data lines of the data lines coupled to a plurality of second pixels; and a third demultiplexer configured to supply third data signals of the data signals to third data lines of the data lines coupled to a plurality of third pixels.

A final control signal of the control signals supplied during the data period may be at least partially overlapped with the scan signal

A supplying order for the plurality of data signals supplied to the plurality of data lines may be based on a supplying order of the control signals.

The demultiplexer controller may be configured to supply the control signals in a first order during an i (i indicates an integer) frame period, and may be configured to supply the control signals in a second order which is reversed from the first order during an i+1 frame period.

The demultiplexer controller may be configured to change the supplying order of the control signals for each horizontal period.

The scan signal may be supplied in a first order and then a second order, which is a reverse order with respect to the first order, based on the horizontal period.

An organic light emitting display device according to another embodiment of the present invention includes: a scan driver configured to supply a scan signal to a scan line during a scan period of a horizontal period; a data driver configured to supply a plurality of data signals to a plurality of output lines during a data period of the horizontal period; a demultiplexer unit configured to transmit a plurality of data signals to a plurality of data lines according to a plurality of control signals; and a demultiplexer controller configured to supply first control signals according to a supplying order, which is changed in each frame, and configured to supply second control signals according to a supplying order, which is constant regardless of the frame, to the demultiplexer unit; wherein the demultiplexer unit comprises: a first demultiplexer configured to supply a plurality of first data signals to a first set of the data lines that are coupled to a plurality of first pixels; and a second demultiplexer configured to supply a plurality of second data signals to a second set of the data lines that are coupled to second and third pixels.

A final first control signal of the first control signals and a final second control signal of the second control signals, which are supplied during the data period, may be at least partially overlapped with the scan signal.

The first pixels may be configured to generate one color of light among red, green, and blue light.

The second demultiplexer may be configured to supply the second data signals to the plurality of data lines coupled to the second and third pixels in a constant order corresponding to the second control signals.

The first demultiplexer may be configured to supply the first data signals to the data lines coupled to the first pixels in a supplying order that changes in each frame according to the first control signals.

The demultiplexer controller may be configured to supply the first control signals in a first order during an i (i indicates an integer) frame period, and may be configured to supply the first control signals in a second order, which is reversed with respect to the first order, during an i+1 frame period.

The demultiplexer controller may be configured to change a supplying order of the first control signals for each horizontal period.

The demultiplexer controller may be configured to supply the first control signals in a first order and then a second order, which is a reverse order with respect to the first order, based on the horizontal period.

### BRIEF DESCRIPTION OF THE DRAWINGS

The accompanying drawings, together with the specification, illustrate exemplary embodiments of the present invention, and, together with the description, serve to explain the principles of the embodiments of the present invention.

FIG. 1 is a view illustrating an organic light emitting display device according to an embodiment of the present invention.

FIG. 2 is a schematic circuit diagram of a demultiplexer according to a first embodiment of the present invention.

FIGS. 3A and 3B are timing diagrams illustrating the first embodiment of a method of driving the demultiplexer shown in FIG. 2.

FIGS. 4A and 4B are timing diagrams illustrating a second embodiment of the method of driving the demultiplexer shown in FIG. 2.

FIG. 5 is a schematic circuit diagram of a demultiplexer according to the second embodiment of the present invention.

FIGS. 6A and 6B are timing diagrams illustrating the embodiment of the method of driving the demultiplexer shown in FIG. 5.

FIG. 7 is a schematic circuit diagram of a demultiplexer according to a third embodiment of the present invention.

FIGS. 8A and 8B are timing diagrams illustrating the embodiment of the method of driving the demultiplexer shown in FIG. 7.

FIG. 9 is a schematic circuit diagram of a demultiplexer according to fourth embodiment of the present invention.

FIGS. 10A and 10B are timing diagrams illustrating the embodiment of the method of driving the demultiplexer shown in FIG. 9.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

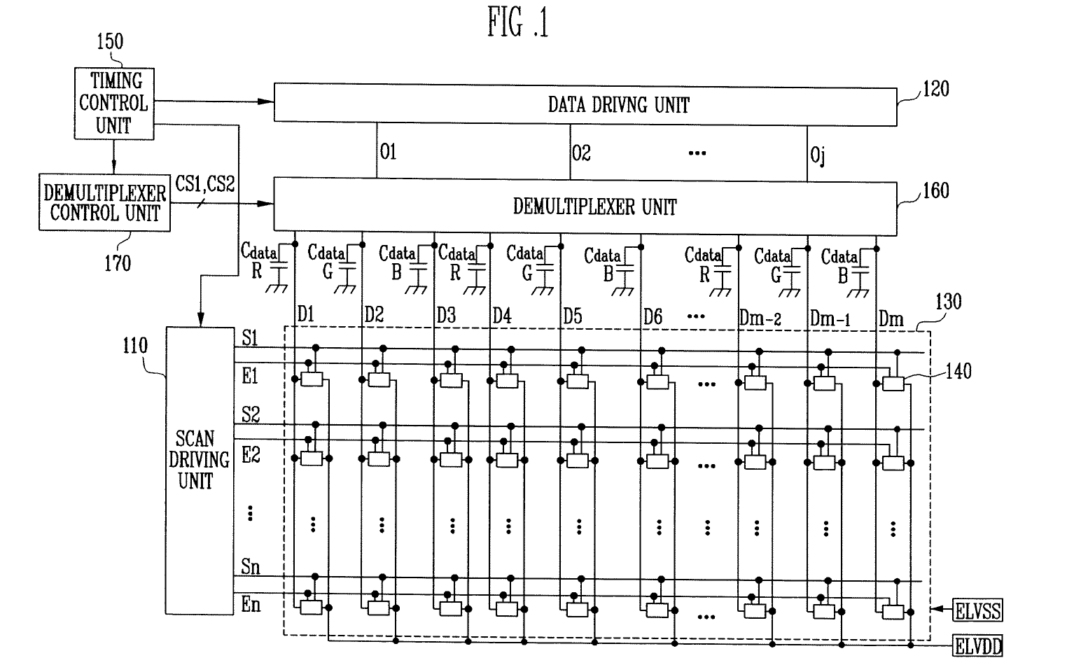

Hereinafter, exemplary embodiments of the present invention that may be practiced without undue experimentation by those skilled in the art to which the present invention pertains will be described in detail with reference to FIGS. 1 to 10B.

FIG. 1 is a view illustrating an organic light emitting display device according to an embodiment of the present invention.

Referring to FIG. 1, the organic light emitting display device according to an embodiment of the present invention includes a pixel unit (or display) 130 including pixels 140 positioned at crossing regions between scan lines S1 to Sn and data lines D1 to Dm, a scan driving unit (or scan driver) 110 for driving the scan lines S1 to Sn and emitting light control lines (or emission control lines) E1 to En, and a data driving unit (or data driver) 120 for driving the data lines D1 to Dm.

Also, the organic light emitting display device according to an exemplary embodiment of the present invention includes a demultiplexer unit 160 positioned between the data driving unit 120 and the data lines D1 to Dm, a demultiplexer control unit 170 for supplying control signals CS1 and CS2 to the demultiplexer unit 160, and a timing control unit 150 for controlling the scan driving unit 110, the data driving unit 120, and the demultiplexer control unit 170.

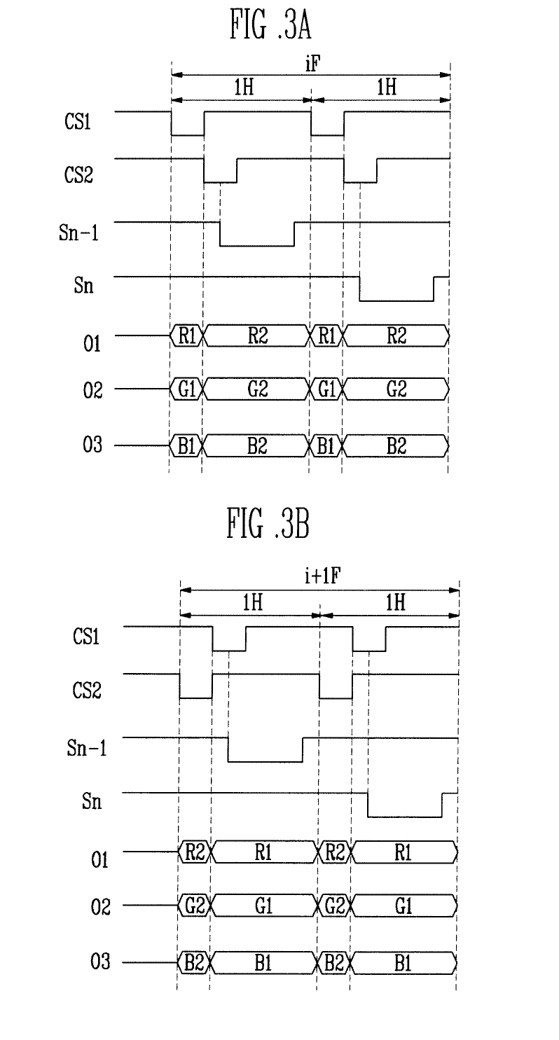

The scan driving unit 110 supplies the scan signals to the scan lines S1 to Sn and supplies the emission control signals to emission control lines E1 to En. Here, the scan Driving unit 110 supplies the scan signals during a scan period of a horizontal period 1H, as illustrated in FIG. 3A. In addition, the scan driving unit 110 supplies the emission control signal to a k-th emission control line Ek so as to overlap the scan signal supplied to a k-th scan line Sk (k indicates a natural number). Here, supply-timing of the emission control lines E1 to En is controlled according to the design of a circuit structure of the pixel 140. In addition, the emission control lines E1 to En may be removed according to the design of a structure of the pixel 140.

The data driving unit 120 generates the data signals and then supplies the generated data signals to the output lines O1 to Oj. Here, the data driving unit 120 sequentially supplies a plurality of the data signals to the output lines O1 to Oj, respectively, during the horizontal period 1H. For example, as described in FIG. 3A, the data driving unit 120 may sequentially supply two data signals to each of the output lines O1 to Oj during a data period of the horizontal period 1H in synchronization with the control signals CS1 and CS2.

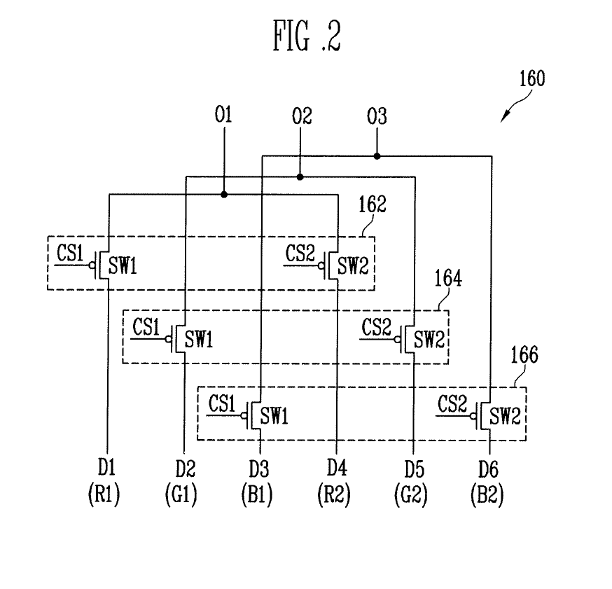

The demultiplexer unit 160 includes a plurality of demultiplexers, which are illustrated, for example, in FIGS. 2, 5, 7, and 9. For example, the demultiplexer unit 160 may include a plurality of demultiplexers coupled to the output lines O1 to Oj, respectively. The demultiplexers, coupled to one of the output lines O1 to Oj, transmit a plurality of the data signals, which are supplied to the corresponding one of the output line O1 to Oj, to a plurality of the data lines corresponding to the control signals CS1 and CS2. Here, in the case in which one of the demultiplexers transmits the data signals, supplied to one of the output lines O1 to Oj, to two of the data lines D1 to Dm, the number of the output lines O1 to Oj included in the data driving unit 120 may be set to ½ in comparison to the number of data lines.

The demultiplexer control unit 170 sequentially supplies the control signals CS1 and CS2 during the data period of the horizontal period so that the plurality of the data signals are divided into a plurality of the data lines D1 to Dm and supplied. For example, the demultiplexer control unit 170 may supply the first and second control signals CS1 and CS2 during the data period.

Also, the demultiplexer control unit 170 of embodiments according to the present invention may change a supplying order of the first and second control signals CS1 and CS2 by frame (e.g., to be different for each frame) and/or during the horizontal period so as to provide a substantially constant average charging voltage between the pixels. For example, the demultiplexer control unit 170 may supply the control signals CS1 and CS2 in a first order during an i (i indicates odd number or even number, or an integer) frame period, and may supply the control signals CS1 and CS2 in a second order which is reversed with respect to the first order (e.g., in a reverse order from) during an i+1 frame period. In relation to this, detail description thereof will be described below with reference to example structures of the demultiplexer.

Data capacitors Cdata are formed on the data lines D1 to Dm, respectively. The data capacitors Cdata temporally store the data signals supplied to each of the data lines D1 to Dm, and supply the stored data signal supplies to the corresponding pixel 140. Here, the data capacitor Cdata serves as a parasitic capacitor equivalently formed on the corresponding data line D1 to Dm. In one embodiment, the parasitic capacitor equivalently formed on each of the data lines D1 to Dm has larger capacitance than that of the storage capacitor formed on each of the pixels 140 so as to more stably store the data signals.

The timing control unit 150 controls the scan driving unit 110, the data driving unit 120, and the demultiplexer control unit 170.

The display unit 130 includes the pixels 140 positioned at crossing regions of the scan lines S1 to Sn and the data lines D1 to Dm. Here, the pixels 140 receive voltage of the second power ELVSS set to be lower than that of the first power ELVDD. The amount of the first voltage ELVDD relative to the second voltage ELVSS controls the amount of current which flows from the first voltage ELVDD to the second voltage ELVSS through an organic light emitting diode so as to generate light (e.g., light having a predetermined brightness) for each corresponding pixel 140. Meanwhile, a structure of the pixel 140 may vary according to design and function of the pixel 140. For example, any suitable pixel configuration may be used.

FIG. 2 is a schematic circuit diagram of a demultiplexer unit 160 according to a first embodiment of the present invention. In FIG. 2, the demultiplexers 162, 164, and 166 coupled to a first output line O1, a second output line O2, and a third output line O3, respectively, will be described for convenience of explanation.

Referring to FIG. 2, the demultiplexer unit 160 according to the first embodiment of the present invention includes the demultiplexers 162, 164, and 166 respectively coupled to the output lines O1 to O3. Here, each of the demultiplexers 162, 164, and 166 transmits a plurality of the data signals, supplied to the output lines O1 to O3, to the pixels 140 configured to emit the same color.

In other words, a first demultiplexer 162 transmits the plurality of data signals supplied to the first output line O1 to the first pixels, which are configured to generate a red color light. To this end, the first demultiplexer 162 is coupled to the first data line D1 and the fourth data line D4, which are electrically coupled to the first pixels.

A second demultiplexer 164 transmits the plurality of data signals supplied to the second output line O2 to the second pixels, which are configured to generate a green color light. To this end, the second demultiplexer 164 is electrically coupled to the second data line D2 and the fifth data line D5, which are electrically coupled to the second pixels.

A third demultiplexer 166 transmits the plurality of data signals supplied to the third output line O3 to the third pixels, which are configured to generate a blue color light. To this end, the third demultiplexer 166 is electrically coupled to the third data line D3 and the sixth data line D6, which are electrically coupled to the third pixels.

Meanwhile, each of the demultiplexers 162, 164, and 166 includes a first switching device SW1 and a second switching device SW2 in order to transmit the two data signals supplied to one output line (e.g., one of O1 to O3) to two data lines (e.g., D1 and D4, D2 and D5, or D3 and D6, respectively).

Here, one of the first switching devices SW1 is coupled between the output lines O1 to O3 and the data lines D1 to D3, respectively, and is turned on when the first control signal CS1 is supplied. One of the second switching devices SW2 is coupled between the output lines O1 to O3 and the data lines D4 to D6, respectively, and is turned on when the second control signal CS2 is supplied.

FIGS. 3A and 3B are timing diagrams illustrating the first embodiment of a method of driving the demultiplexer shown in FIG. 2.

Referring to FIGS. 3A and 3B, first, the horizontal period is divided into the data period, during which the control signals CS1 and CS2 are supplied, and the scan period, during which the scan signals are supplied. The demultiplexer control unit 170 may supply the control signals in order of the first and second control signals CS1 and CS2 during the data period of the i frame iF horizontal period.

When the first control signal CS1 is supplied, the first switching device SW1 is turned on so as to supply the data signals R1, G1, and B1 to the data lines D1 to D3. In addition, when the second control signal CS2 is supplied, the second switching device SW2 is turned on so as to supply the data signals R2, G2, and B2 to the data lines D4 to D6.

The data signals supplied to the data lines D1 to D6 are stored in the data capacitor Cdata coupled to each of the data lines D1 to D6. And then, the scan signals are supplied so as to at least partially overlap the final control signal, control signal CS2, which is the final control signal supplied during the data period of the i frame iF horizontal period. When the scan signals are supplied, the pixels 140 are selected by horizontal line, and the data signals stored in the data capacitor Cdata are supplied to the pixels 140 by horizontal line.

Meanwhile, the demultiplexer control unit 170 may supply the control signals according to an order of the second and first control signals CS2 and CS1 during the data period of the i+1 frame i+1F horizontal period.

When the second control signal CS2 is supplied, then the second switching device SW2 is turned on so as to supply the data signals R2, G2, and B2 to the data lines D4 to D6. When the first control signal CS1 is supplied, then the first switching device SW1 is turned on so as to supply the data signals R1, G1, and B1 to the data lines D1 to D3. The scan signals are supplied so as to overlap the final control signal, control signal CS1, which is the final control signal supplied during the data period of the i+1 frame i+1F horizontal period. When the scan signals are supplied, the pixels 140 are selected by horizontal line, and the data signals stored in the data capacitor Cdata are supplied to the pixels 140 by horizontal line.

Meanwhile, although the same data signals are supplied, voltage charged to the pixel 140 is different according to a supplying order of the control signals CS1 and CS2. In other words, the data signals supplied because of previously supplied control signal CS1 or CS2 are stored in the data capacitor Cdata and then are supplied to the pixel 140. In addition, the data signals supplied because of the control signals CS2 or CS1 which are lately supplied are directly supplied from the data driving unit 120 by overlapping the scan signals with the control signals. In this case, a difference in charge voltage between the pixels 140 is generated according to the supplying order of the control signals CS1 and CS2.

According to embodiments of the present invention, the supplying order of the first control signal CS1 and the second control signal CS2 between the frames is changed such that the difference as described above is to be constant. Therefore, the voltage charged to the pixels 140 is substantially constant on average, therefore, vertical line shaped image defects may be prevented, substantially prevented, or reduced.

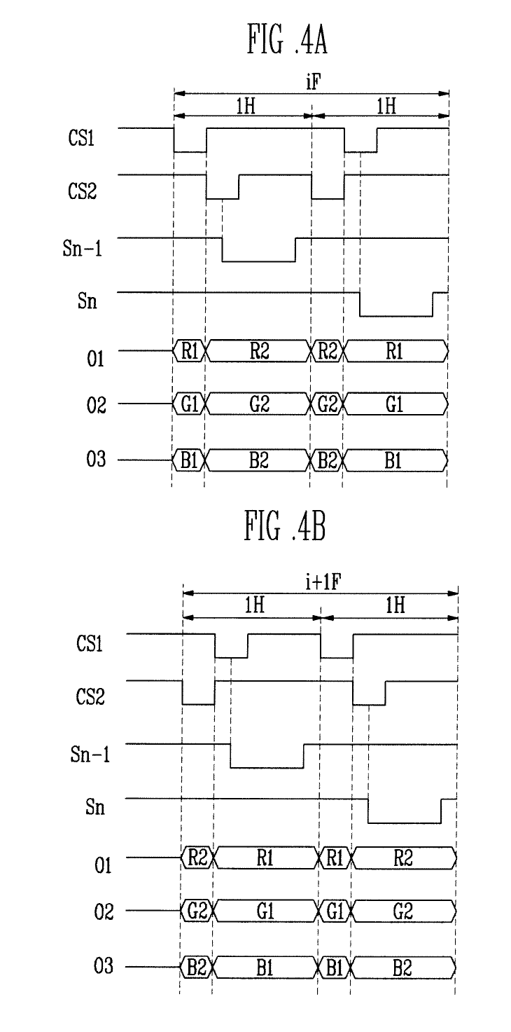

FIGS. 4A and 4B are timing diagrams illustrating a second embodiment of the method of driving the demultiplexer shown in FIG. 2. When FIGS. 4A and 4B are described, detailed descriptions of the same parts with respect to FIGS. 3A and 3B may be omitted.

Referring to FIGS. 4A and 4B, the supplying order of the first and second control signals CS1 and CS2 is changed for a frame (e.g., frame by frame) and horizontal period unit according to the second embodiment of the present invention.

For example, during the i horizontal period iH of the i frame iF, the scan signals are supplied in an order of the first control signal CS1 followed by the second control signal CS2, and the scan signals are supplied in an order of the second control signal CS2 followed by the first control signal CS1 during the i+1 horizontal period 1H.

In addition, during the i horizontal period iH of the i+1 frame i+iF, the control signals are supplied in the order of the second to first control signals CS2 and CS1, and the control signals are supplied in the order of the first to second control signals CS1 and CS2 during the i+1 horizontal period 1H. Therefore, the voltage charged to the pixels 140 is substantially constant on average and, accordingly, an image having a substantially constant or uniform brightness may be displayed.

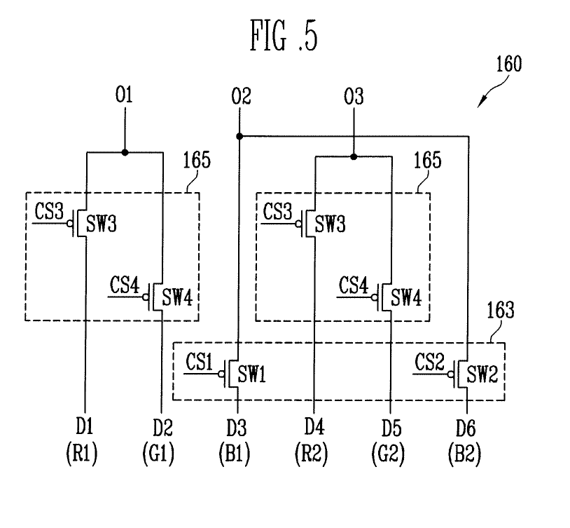

FIG. 5 is a view illustrating a demultiplexer unit 160 according to the second embodiment of the present invention. FIG. 5 will be described with reference to differences from the first embodiment of the present invention.

Referring to FIG. 5, the demultiplexer unit 160 according to another exemplary embodiment of the present invention includes the demultiplexer 163 coupled to the output line O2, and the demultiplexer 165 coupled to the output lines O1 and O3. Here, the fourth demultiplexer 163 transmits a corresponding data signal to the pixels 140 for emitting a same color of light. In addition, the fifth demultiplexer 165 transmits a corresponding data signal to adjacent pixels 140 that are configured to emit different colors of light.

For example, the fourth demultiplexer 163 transmits a data signal to the third pixel for emitting a blue color light. To this end, the fourth demultiplexer 163 is coupled to a third data line D3 and the sixth data line D6. The fourth demultiplexer 163 as described above includes one of the first switching devices SW1 positioned between the third data line D3 and the second output line O2 and one of the second switching devices SW2 positioned between the sixth data line D6 and the second output line O2. The first switching device SW1 of the fourth demultiplexer 163 is turned on when the first control signal CS1 is supplied, and the second switching device SW2 is turned on when the second control signal CS2 is supplied.

The fifth demultiplexer 165 transmits the data signal to the data line coupled to a first pixel and a second pixel adjacent to the first pixel. To this end, the demultiplexer 165 is coupled to the first output line O1 and also coupled to the first data line D1 and the second data line D2. In addition, the demultiplexer 165 is coupled to the third output line O3 and is coupled to the fourth data line D4 and the fifth data line D5.

The fifth demultiplexer 165 includes a third switching device SW3 and a fourth switching device SW4 in order to transmit the two data signals supplied to one of the output lines O1 or O3 to the corresponding two data lines D1 and D2, and D4 and D5, respectively.

Here, the third switching device SW3 is coupled between the output lines O1 and O3 and the data lines D1 and D4, respectively, and is turned on when the third control signal CS3 is supplied. The fourth switching device SW4 is coupled between the output lines O1 and O3 and the data lines D2 to D5, respectively, and is turned on when the fourth control signal CS4 is supplied.

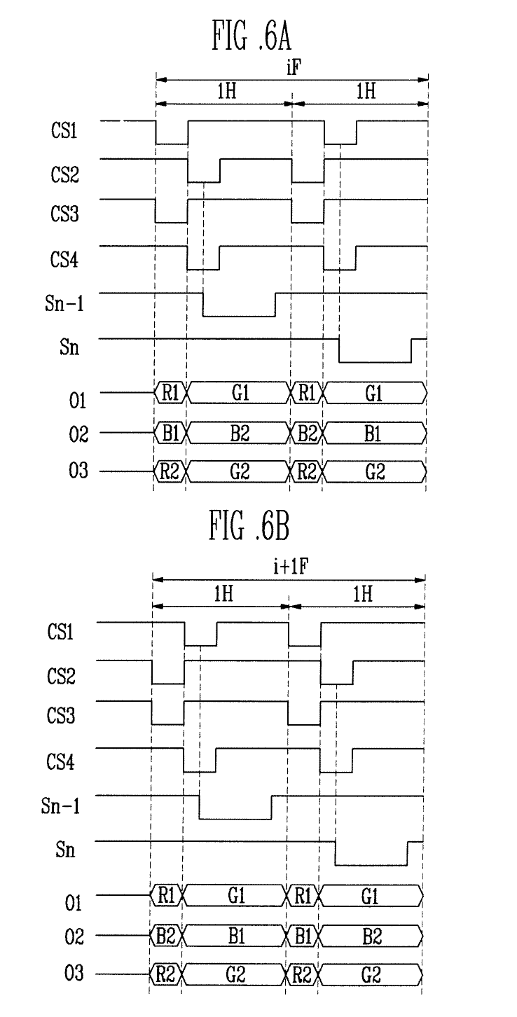

FIGS. 6A and 6B are timing diagrams illustrating the embodiment of the method of driving the demultiplexer unit 160 shown in FIG. 5.

Referring to FIGS. 6A and 6B, during the data period of the i frame iF and i+1 frame i+1F horizontal period, the third control signal CS3 and the fourth control signal CS4 are supplied in same order. Then, during each frame data period, the third switching device SW3 and the fourth switching device SW4 are sequentially turned on to supply the data signals to the data lines D1, D2, D4, and D5.

A supplying order of the first control signal CS1 and the second control signal CS2 is changed for each horizontal period unit. The first control signal CS1 and the second control signal CS2 may be changed in a frame unit. In other words, during the i horizontal period iH of the i frame iF, the scan signals are supplied according to the order of the control signals (e.g., the first control signal CS1 followed by the second control signal CS2), and the scan signals are supplied according to the order of the control signals (e.g., the second control signal CS2 followed by the first control signal CS1) during the i+1 horizontal period 1H. In addition, during the i horizontal period iH of the i+1 frame i+iF, the control signals are supplied in the order of the second control signal CS2 followed by the first control signal CS1, and the control signals are supplied in the order of the first control signal CS1 followed by the second control signal CS2 during the i+1 horizontal period 1H.

When a supplying order of the first control signal CS1 and the second control signal CS2 is changed in a frame or horizontal period unit, a supplying order of the data signal supplied to the data lines D3 and D6 is changed in a frame or horizontal period unit. That is, a supplying order of the data signal of the first switching device SW1 and the second switching device SW2 is changed according to a turn-on order, therefore, a substantially uniform image may be displayed on the third pixels on average.

In more detail, according to the described-demultiplexer of the second embodiment of the present invention, varying a supplying order of the data signal depending on a color of the pixels may prevent, substantially prevent, or reduce images with vertical line shaped defects.

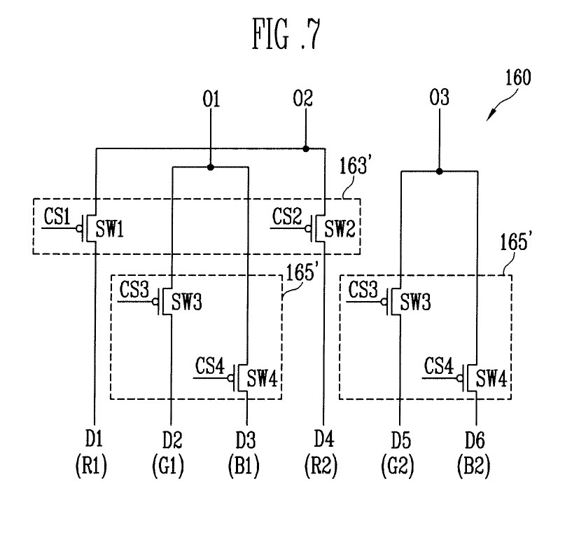

FIG. 7 is a schematic circuit diagram showing a demultiplexer unit 160 according to third embodiment of the present invention. FIG. 7 will be described with reference to differences with respect to the previously-described embodiments of the present invention.

Referring to FIG. 7, the demultiplexer unit 160 according to the third embodiment of the present invention includes the demultiplexer 163′ coupled to the output line O2 and the demultiplexer 165′ coupled to the output lines O1 and O3. Here, the fourth demultiplexer 163′ transmits the data signal to the pixels 140 that are configured to emit a same color of light. In addition, the fifth demultiplexer 165′ transmits the data signal to the adjacent pixels 140 for emitting different colors of light.

For example, the fourth demultiplexer 163′ may transmit a corresponding data signal to the first pixels configured to emit a red color light. To this end, the fourth demultiplexer 163′ includes the first switching device SW1 and the second switching device SW2 formed between the output line O1 and the data lines D1 and D4. The first switching device SW1 is turned on when the first control signal CS1 is supplied to the gate electrode of the first switching device SW1, and the second switching device SW2 is turned on when the second control signal CS2 is supplied to the gate electrode of the second switching device SW2.

The fifth demultiplexer 165′ transmits the corresponding data signal to the data line coupled to the second pixel and the third pixel that are adjacent to each other. The fifth demultiplexer 165′ as described above includes the third switching device SW3 and the fourth switching device SW4 in order to transmit the corresponding data signal supplied to the output lines O1 and O3 to two data lines D2 and D3, and D5 and D6, respectively. The third switching device SW3 is turned on when the third control signal CS3 is supplied, and the fourth switching device SW4 is turned on when the fourth control signal CS4 is supplied.

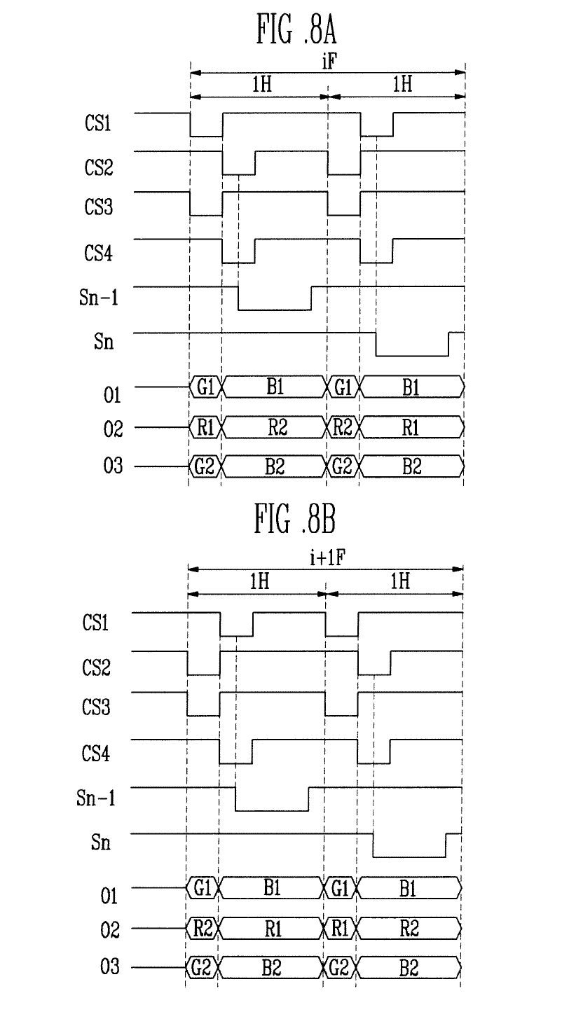

FIGS. 8A and 8B are timing diagrams of the embodiment of the method of driving the demultiplexer unit shown in FIG. 7.

Referring to FIGS. 8A and 8B, during the data period of the i frame iF and i+1 frame i+1F horizontal period, the third control signal CS3 and the fourth control signal CS4 are supplied in same order. And then, during the each frame data period, the third switching device SW3 and the fourth switching device SW4 are sequentially turned on to supply the data signals to the data lines D2, D3, D5, and D6.

The supplying order of the first control signal CS1 and the second control signal CS2 is changed for each horizontal period unit. The first control signal CS1 and the second control signal CS2 may be changed in a frame unit. In other words, during the i horizontal period iH of the i frame iF, the scan signals are supplied in the order of the first control signal CS1 followed by the second control signal CS2, and the scan signals are supplied in the order of the second control signal CS2 followed by the first control signal CS1 during the i+1 horizontal period 1H. In addition, during the i horizontal period iH of the i+1 frame i+iF, the control signals are supplied in the order of the second control signal CS2 followed by the first control signal CS1, and the control signals are supplied in the order of the first control signal CS1 followed by the second control signal CS2 during the i+1 horizontal period 1H.

When a supplying order of the first control signal CS1 and the second control signal CS2 is changed in a frame or horizontal period unit, a supplying order of the data signal supplied to the data lines D1 and D4 is changed in a frame or horizontal period unit. That is, a supplying order of the data signal of the first switching device SW1 and the second switching device SW2 is changed according to a turn-on order, therefore, a more uniform image may be displayed by the first pixels on average.

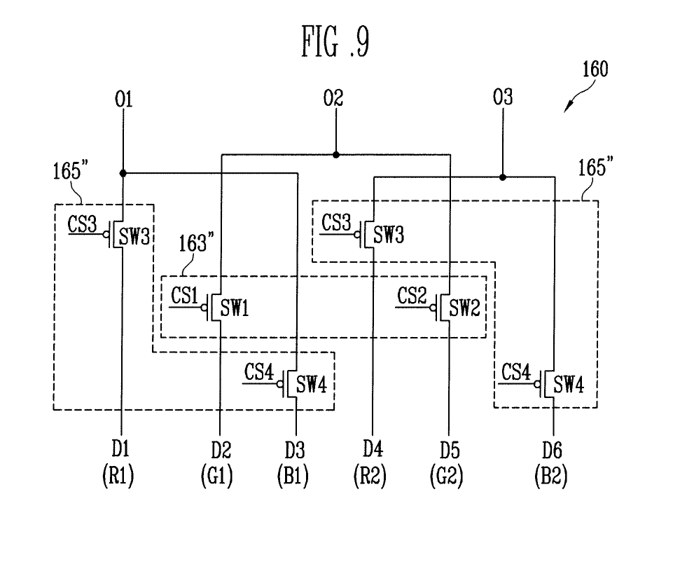

FIG. 9 is a view showing a demultiplexer unit 160 according to fourth embodiment of the present invention. FIG. 9 will be described primarily with reference to differences with respect to the second embodiment of the present invention shown in FIG. 5.

Referring to FIG. 9, the demultiplexer unit 160 according to the fourth embodiment of the present invention includes the demultiplexer 163″ coupled to the output line O2 and the demultiplexer 165″ coupled to the output lines O1 and O3. Here, the fourth demultiplexer unit 163″ transmits the data signals to the pixels 140 that are configured to emit a same color light. In addition, the fifth demultiplexer unit 165″ transmits the data signals to adjacent pixels 140 for emitting different colors of light.

The fourth demultiplexer unit 163″ transmits the data signals to the second pixels for emitting a green color light. To this end, the fourth demultiplexer unit 163″ includes the first switching device SW1 and the second switching device SW2 coupled between the output line O1 and the data lines D2 and D5. The first switching device SW1 is turned on when the first control signal CS1 is supplied, and the second switching device SW2 is turned on when the second control signal CS2 is turned on.

The fifth demultiplexer unit 165″ transmits the data signals to the data lines coupled the first pixel and the third pixel adjacent to each other. The fifth demultiplexer unit 165″ as described above includes the third switching device SW3 and the fourth switching device SW4 in order to transmit corresponding data signals supplied to the output lines O1 and O3 to two data lines D1 and D3, and D4 and D6, respectively. The third switching device SW3 is turned on when the third control signal CS3 is supplied to a gate electrode of the third switching device SW3, and the third switching device SW4 is turned on when the fourth control signal CS4 is supplied.

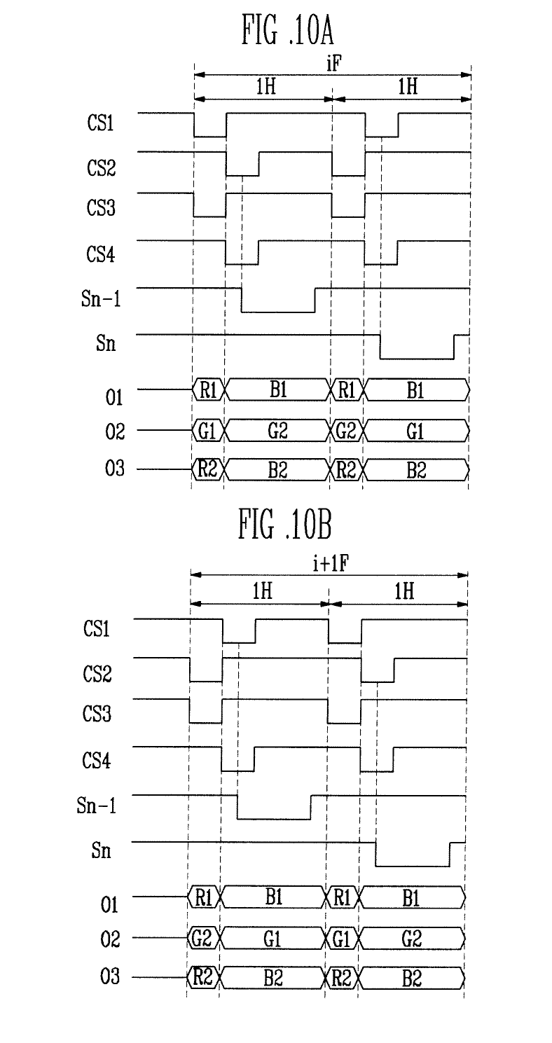

FIGS. 10A and 10B are views illustrating the embodiment of the method of driving the demultiplexer unit 160 shown in FIG. 9.

Referring to FIGS. 10A and 10B, during the data period of the i frame iF and i+1 frame i+1 F horizontal period, the third control signal CS3 and the fourth control signal CS4 are supplied in same order. And then, during the each frame data period, the third switching device SW3 and the fourth switching device SW4 are sequentially turned on to supply the data signals to the data lines D1, D3, D4, and D6.

A supplying order of the first control signal CS1 and the second control signal CS2 is changed for each horizontal period unit. The first control signal CS1 and the second control signal CS2 may be changed in a frame unit. In other words, during the i horizontal period iH of the i frame iF, the scan signals are supplied in the order of the first control signal CS1 followed by the second control signal CS2, and the scan signals are supplied in the order of the second control signal CS2 followed by the first control signal CS1 during the i+1 horizontal period 1H. In addition, during the i horizontal period iH of the i+1 frame i+iF, the control signals are supplied in the order of the second control signal CS2 followed by the first control signal CS1, and the control signals are supplied in the order of the first control signal CS1 followed by the second control signal CS2 during the i+1 horizontal period 1H.

When a supplying order of the first control signal CS1 and the second control signal CS2 is changed in a frame or horizontal period unit, a supplying order of the data signal supplied to the data lines D2 and D5 is changed in a frame or horizontal period unit. That is, a supplying order of the data signal of the first switching device SW1 and the second switching device SW2 is changed according to a turn-on order, therefore, a more uniform image may be displayed by the first pixels on average.

Meanwhile, the present invention may be used to a structure in which an organic light emitting display diode emits a red color light, a green color light, and a blue color light and a structure in which an organic light emitting display diode emits a white color light. In other words, the present invention may be used for various shaped display devices including a demultiplexer.

As set forth above, the organic light emitting display device according to the present invention changes the supplying order of the control signals supplied to the demultiplexer based on a frame and/or a horizontal period. In this case, the charge voltage supplied to the pixels 140 is substantially constant on average, thereby making it possible to prevent, substantially prevent, or reduce vertical line shaped image defects.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and their equivalents.

What is claimed is:

1. An organic light emitting display device comprising,
a scan driver configured to supply a scan signal to a scan line during a scan period of a horizontal period;
a data driver configured to supply a plurality of data signals to a plurality of output lines during a data period of the horizontal period;
a demultiplexer configured to transmit the data signals through the output lines to a plurality of data lines according to a plurality of control signals; and
a demultiplexer controller configured to supply the control signals to the demultiplexer, with a supply order of the control signals being changed for each frame.

2. The organic light emitting display device according to claim 1,
wherein a final control signal of the control signals supplied during the data period is at least partially overlapped with the scan signal.

3. The organic light emitting display device according to claim 1,
wherein the demultiplexer controller is configured to supply the control signals in a first order during an i (i indicates an integer) frame period, and is configured to supply the control signals in a second order, which is reversed from the first order, during an i+1 frame period.

4. The organic light emitting display device according to claim 1,
wherein the demultiplexer controller is configured to change a supplying order of the control signals for each horizontal period.

5. The organic light emitting display device according to claim 4,
wherein the scan signal is supplied in a first order and then a second order, which is reversed from the first order, based on the horizontal period.

6. An organic light emitting display device comprising,
a scan driver configured to supply a scan signal to a scan line during a scan period of a horizontal period;
a data driver configured to supply a plurality of data signals to a plurality of output lines during a data period of the horizontal period;
a demultiplexer unit configured to transmit the data signals through the output lines to a plurality of data lines according to a plurality of control signals; and
a demultiplexer control unit configured to supply the control signals to a plurality of demultiplexers while a supply order of the control signals is changed in each frame;
wherein the demultiplexers comprise:
a first demultiplexer configured to supply first data signals of the data signals to first data lines of the data lines coupled to a plurality of first pixels;
a second demultiplexer configured to supply second data signals of the data signals to second data lines of the data lines coupled to a plurality of second pixels; and
a third demultiplexer configured to supply third data signals of the data signals to third data lines of the data lines coupled to a plurality of third pixels.

7. The organic light emitting display device according to claim 6,
wherein a final control signal of the control signals supplied during the data period is at least partially overlapped with the scan signal.

8. The organic light emitting display device according to claim 6,
wherein a supplying order for the plurality of data signals supplied to the plurality of data lines is based on a supplying order of the control signals.

9. The organic light emitting display device according to claim 8,
wherein the demultiplexer control unit is configured to supply the control signals in a first order during an i (i indicates an integer) frame period, and is configured to supply the control signals in a second order which is reversed from the first order during an i+1 frame period.

10. The organic light emitting display device according to claim 8,
wherein the demultiplexer control unit is configured to change the supplying order of the control signals for each horizontal period.

11. The organic light emitting display device according to claim 10,
wherein the scan signal is supplied in a first order and then a second order, which is a reverse order with respect to the first order, based on the horizontal period.

12. An organic light emitting display device comprising,
a scan driver configured to supply a scan signal to a scan line during a scan period of a horizontal period;
a data driver configured to supply a plurality of data signals to a plurality of output lines during a data period of the horizontal period;
a demultiplexer unit configured to transmit the plurality of data signals to a plurality of data lines according to a plurality of control signals; and
a demultiplexer controller configured to supply first control signals according to a supplying order, which is changed in each frame, and configured to supply second control signals according to a supplying order, which is constant regardless of the frame, to the demultiplexer unit;
wherein the demultiplexer unit comprises:
a first demultiplexer configured to supply a plurality of first data signals to a first set of the data lines that are coupled to a plurality of first pixels; and
a second demultiplexer configured to supply a plurality of second data signals to a second set of the data lines that are coupled to second and third pixels.

13. The organic light emitting display device according to claim 12,
wherein a final first control signal of the first control signals and a final second control signal of the second control signals, which are supplied during the data period, are at least partially overlapped with the scan signal.

14. The organic light emitting display device according to claim 12,
wherein the first pixels are configured to generate one color of light among red, green, and blue light.

15. The organic light emitting display device according to claim 12,
wherein the second demultiplexer is configured to supply the second data signals to the plurality of data lines coupled to the second and third pixels in a constant order corresponding to the second control signals.

16. The organic light emitting display device according to claim 12,
wherein the first demultiplexer is configured to supply the first data signals to the data lines coupled to the first pixels in a supplying order that changes in each frame according to the first control signals.

17. The organic light emitting display device according to claim 16,
wherein the demultiplexer controller is configured to supply the first control signals in a first order during an i (i indicates an integer) frame period, and is configured to supply the first control signals in a second order, which is reversed from the first order, during an i+1 frame period.

18. The organic light emitting display device according to claim 16,
wherein the demultiplexer controller is configured to change a supplying order of the first control signals for each horizontal period.

19. The organic light emitting display device according to claim 18,
wherein the demultiplexer controller is configured to supply the first control signals in a first order and then a second order, which is a reverse order from the first order, based on the horizontal period.
